(19) United States
(12) Patent Application Publication
(10) Pub. No.: US 2009/0238914 A1
(43) Pub. Date: Sep. 24, 2009

(54) FEED MECHANISM OF MOLD

(75) Inventors: Chih-Yu CHEN, Taipei Hsien (TW); Jian-Guang HUANG, Taipei Hsien (TW); Chun-Yan WU, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/050,905

(22) Filed: Mar. 18, 2008

(51) Int. Cl. B29C 45/27

(52) U.S. Cl. 425/572

(57) ABSTRACT

A feed mechanism of mold includes a top plate, an injection body and two slides. The top plate defines a recess in the bottom for receiving the two slides. The injection body is disposed in the top of the top plate and defines a sprue at the top thereof, a first pouring runner and a second runner both connecting with the sprue. The bottom of the first pouring runner penetrates through the injection body. The slide has a mating surface. The two mating surfaces of the two slides match each other. A shaping recess is defined between the mating surfaces for receiving a core insert. An injection runner is defined between the mating surfaces and connects with the first pouring runner to define a first runner. Two molding cavities are defined among the slides, the core insert and the injection body and connect with the first runner and the second runner respectively.

### BACKGROUND OF THE INVENTION

1. Field of the Invention

The present invention generally relates to a mold, and more particularly to a feed mechanism of mold.

2. The Related Art

Traditionally, some components have more than two isolated portions apart from each other. Accordingly, a feed mechanism of mold defines more than two molding cavities to shape the isolated portions. However, because the feed mechanism of mold has only a runner to inject plastics, the component further designs a connecting portion to connect with the isolated portions. Accordingly, the feed mechanism of mold designs a connecting recess to shape the connecting portion and connect with the molding cavities. The plastics are injected into the molding cavities through the connecting recess and the runner for forming the isolated portions. Meanwhile, the connecting portion is shaped through the connecting recess. After the component is finished in the long run, the connecting portion is removed. However, the design process and the remove process of the connecting portion waste extra manpower and material resources and need to be superseded with a simple method.

### SUMMARY OF THE INVENTION

An object of the present invention is to provide a feed mechanism of mold, which has a first runner and a second runner instead of a connecting portion of a component so as to save manpower and material resources.

The feed mechanism of mold includes a top plate, an injection body and two slides. The top plate defines a recess in the bottom thereof. The injection body is disposed in the top of the top plate and stretches into the recess. The top of the injection body defines a sprue, a first pouring runner and a second runner both connecting with the sprue. A lower end of the first pouring runner penetrates through the injection body. A lower portion of the second runner defines a second tail runner and a pulling mouth. The two slides are received in two sides of the recess of the top plate respectively. Each of the slides has a mating surface. The two mating surfaces of the two slides match each other. A shaping recess is defined between the two mating surfaces for receiving a core insert therein and communicates with the pulling mouth. An injection runner is defined between the two mating surfaces and adjacent to the shaping recess. The injection runner connects with the lower end of the first pouring runner of the injection body to define a first runner. A lower portion of the injection runner defines a first tail runner and a pulling runner. Two molding cavities are defined among the slides, the core insert and the injection body and isolated by the core insert. The two molding cavities connect with the first tail runner and the second tail runner respectively.

As described above, in use, plastics are injected into one molding cavity through the second runner and injected into the other molding cavity through the first runner instead of increasing the connecting portion on the component. Therefore, the design process and the remove process of the connecting portion can be omitted so as to save manpower and material resources.

### BRIEF DESCRIPTION OF THE DRAWINGS

The present invention will be apparent to those skilled in the art by reading the following description of a preferred embodiment thereof, with reference to the attached drawings, in which:

FIG. 1 is a cross-sectional view of a feed mechanism of mold configured on a bottom plate in accordance with the present invention;

FIG. 2 is a perspective view of a top plate of the feed mechanism of mold of FIG. 1;

FIG. 3 is a perspective view of an injection body of the feed mechanism of mold of FIG. 1, the injection body is dissected partly; and

FIG. 4 is a perspective view of two slides of the feed mechanism of mold of FIG. 1.

### DETAILED DESCRIPTION OF THE PREFERRED EMBODIMENT

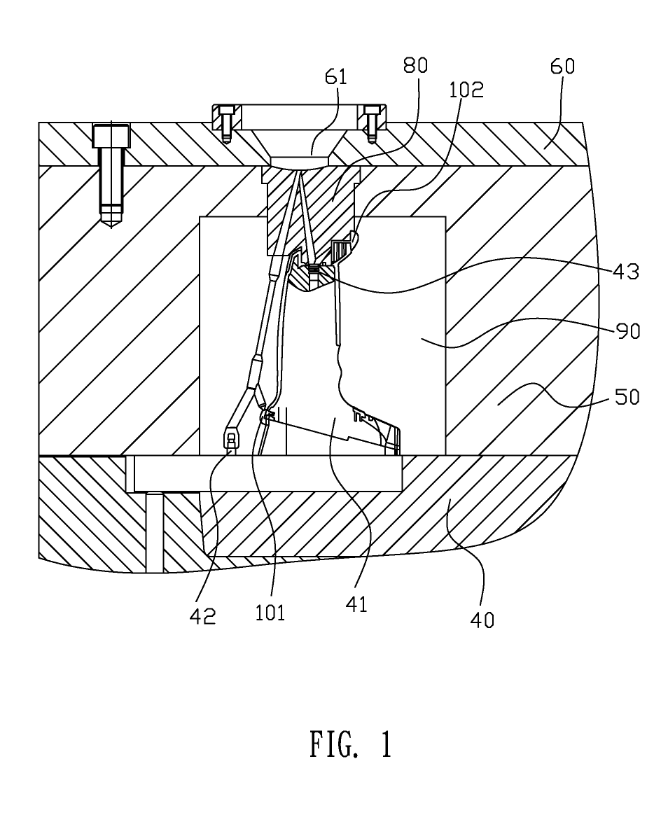

With reference to FIG. 1, a feed mechanism of mold according to the present invention is configured on a bottom plate 40. The bottom plate 40 disposes a core insert 41 on the top thereof, a first puller 42 apart from the left of the core insert 41 and a second puller 43 on the top of the core insert 41. The feed mechanism of mold includes a top plate 50, a top clamping plate 60, an injection body 80 and two slides 90.

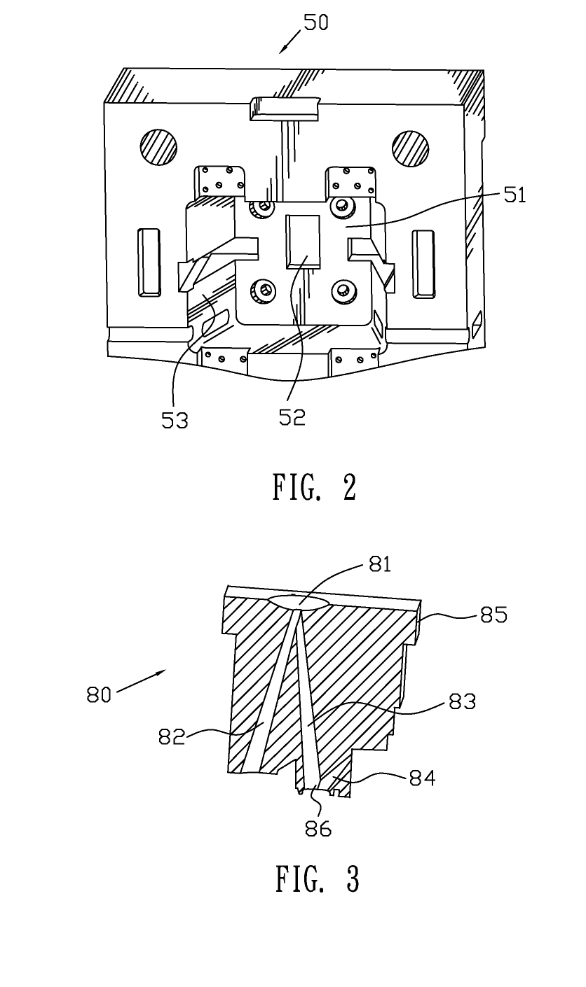

Referring to FIG. 1 and FIG. 2, the top plate 50 is of rectangular shape in substance and the bottom thereof concaves upward to form a recess 51. The recess 51 is of rectangular shape through a front view and is of isosceles trapezoid shape through a lateral view. The recess 51 defines two ramps 53 inclining outside from top to bottom and facing to each other. The middle of the recess 51 extends upward to penetrate through the top of the top plate 50 for defining a rectangular hole 52. The top of the hole 52 extends toward two sides to form a pair of shoulder cavities (not shown). The top clamping plate 60 is fixed on the top of the top plate 50 and defines a funnel-shaped aperture 61 penetrating through from top to bottom.

Referring to FIG. 3, the injection body 80 is of rectangular shape in substance and the top thereof protrudes toward two sides to form a pair of shoulder 85 corresponding to the shoulder cavities of the top plate 50. The top of the injection body 80 defines an arc sprue 81. The bottom of the sprue 81 diverges toward two sides to respectively extend downward to penetrate through the bottom of the injection body 80 for defining a first pouring runner 82 and a second pouring runner 83 locating on the right of the first pouring runner 82. The first pouring runner 82 and the second pouring runner 83 thicken gradually from top to bottom. The bottom of the second pouring runner 83 extends rightward and inclines upward to penetrate through the outside of the injection body 80 for defining a second tail runner 84 thinning gradually from bottom to top. A pulling mouth 86 is defined at the junction of the second pouring runner 83 and the second tail runner 84. The second pouring runner 83, the pulling mouth 86 and the second tail runner 84 define a second runner.

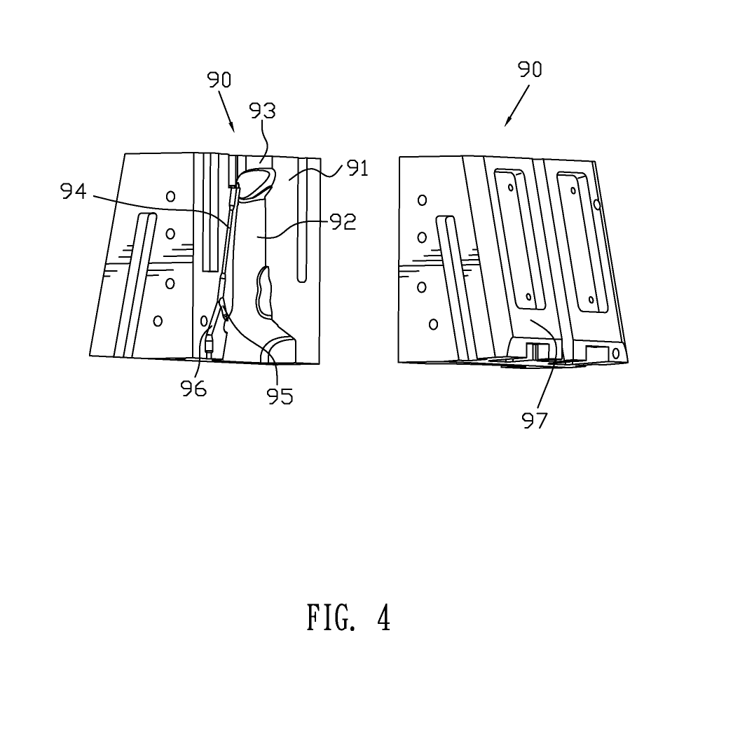

Referring to FIGS. 1 and 4, each of the two slides 90 has a mating surface 91 and an inclined plane 97 defined at two opposite sides of the slide 90. The two mating surfaces 91 of the two slides 90 face to each other and match with each other. The inclined plane 97 inclines outside from top to bottom and matches the respective ramp 53 of the top plate 50. The mating surface 91 defines a shaping recess 92 for receiving half of the core insert 41. The top of the mating surface 91 opens a gap 93 communicating with the shaping recess 92. The mating surface 91 further defines a connecting channel 94 located on the left of the shaping recess 92 and on a line with the first pouring runner 82 of the injection body 80. The middle of the connecting channel 94 is thinner than two ends thereof. The top of the connecting channel 94 communicates with the bottom of the gap 93. The bottom of the connecting channel 94 diverges to respectively extend downward for defining a tail channel 95 communicating with the shaping recess 92 and a pulling channel 96. The pulling channel 96 inclines leftward and then extends downward to penetrate through the bottom of the slide 90.

Referring to FIGS. 1-4, in assembly, the injection body 80 is disposed in the hole 52 of the top plate 50. The shoulder 85 buckles into the corresponding shoulder cavity and the bottom of the injection body 80 stretches into the recess 51 of the top plate 50. The top clamping plate 60 is fixed on the top of the top plate 50. The bottom of the aperture 61 connects with the sprue 81 of the injection body 80. The two slides 90 are received in the recess 51 of the top plate 50 and the inclined planes 97 match with the ramps 53 of the top plate 50 on the top of the bottom plate 40. When the feed mechanism of mold and the bottom plate 40 are closed, the mating surfaces 91 of the two slides 90 match each other. The two gaps 93 join together to receive the bottom of the injection body 80. The two shaping recesses 92 join together to receive the core insert 41. The second puller 43 is inserted into the pulling mouth 86 of the injection body 80. The two pulling channels 96 join together to form a pulling runner for receiving the first puller 42. The two connecting channels 94 buckle with each other to form a connecting runner and the two tail channels 95 buckle with each other to form a first tail runner. The connecting runner, the first tail runner and the pulling runner define an injection runner. The top of the connecting runner connects with the bottom of the first pouring runner 82 of the injection body 80. The first pouring runner 82 and the injection runner define a first runner. The slides 90 and the core insert 41 define a first molding cavity 101 located on the left of the core insert 41 and connecting with the first tail runner for molding an isolated portion. The injection body 80, the slides 90 and the core insert 41 define a second molding cavity 102 located on the right of the core insert 41 and connecting with the second tail runner 84 for molding another isolated portion.

When the feed mechanism of mold and the bottom plate 40 are opened, the top clamping plate 60 and the top plate 50 move upward and further drive the injection body 80 to move upward. The second puller 43 separates from the pulling mouth 86 of the injection body 80 so that plastics remained in the second runner is easier to be cleaned away. Meanwhile, the two slides 90 are pulled by the first puller 42 to stay on the top of the bottom plate 40. Then, under the action of corresponding structures of the bottom plate 40, the two slides 90 horizontally slide to separate from each other. At this moment, the two isolated portions can be withdrawn. And then, the top clamping plate 60 and the top plate 50 move downward and further drive the injection body 80 to move downward. Meanwhile, the inclined planes 97 of the slides 90 and the respective ramps 53 of the top plate 50 interact with each other to drive the slides 90 to horizontally slide along the ramps 53 to match with each other again.

As described above, in use, the two isolated portions of a component are manufactured respectively by injecting the plastics into the first molding cavity 101 through the first runner and by injecting the plastics into the second molding cavity 102 through the second runner instead of increasing a connecting portion on the component. Therefore, the design process and the remove process of the connecting portion can be omitted so as to save manpower and material resources.

What is claimed is:

1. A feed mechanism of mold, comprising:
a top plate defining a recess in a bottom thereof;
an injection body disposed in a top of the top plate and stretching into the recess, a top of the injection body defining a sprue, a first pouring runner and a second runner both connecting with the sprue, a lower end of the first pouring runner penetrating through the injection body, a lower portion of the second runner defining a second tail runner and a pulling mouth; and
two slides received in two sides of the recess of the top plate respectively, each of the slides having a mating surface, the two mating surfaces of the two slides matching each other, a shaping recess being defined between the two mating surfaces for receiving a core insert therein and communicating with the pulling mouth, an injection runner being defined between the two mating surfaces and adjacent to the shaping recess, the injection runner connecting with the lower end of the first pouring runner of the injection body to define a first runner, a lower portion of the injection runner defining a first tail runner and a pulling runner, two molding cavities being defined among the slides, the core insert and the injection body and being isolated by the core insert, the two molding cavities connecting with the first tail runner and the second tail runner respectively.

2. The feed mechanism of mold as claimed in claim 1, wherein the second runner has a second pouring runner connecting the sprue and the second tail runner, the pulling mouth is defined at the junction of the second pouring runner and the second tail runner.

3. The feed mechanism of mold as claimed in claim 1, wherein the injection runner further includes a connecting runner connecting the lower end of the first pouring runner, the first tail runner and the pulling runner meet each other at a lower end of the connecting runner.

4. A feed mechanism of mold, comprising:
a top plate defining a recess in a bottom thereof;
an injection body disposed in a top of the top plate and stretching into the recess, a top of the injection body defining a sprue, two second runners connecting with the sprue, a lower portion of each of the second runners defining a second tail runner and a pulling mouth; and
two slides received in two sides of the recess of the top plate respectively, each of the slides having a mating surface, the two mating surfaces of the two slides matching each other, a shaping recess being defined between the two mating surfaces for receiving a core insert therein and communicating with the pulling mouths, two molding cavities being defined among the slides, the core insert and the injection body and being isolated by the core insert, the two molding cavities connecting with the corresponding second tail runners respectively.

5. A feed mechanism of mold, comprising:
a top plate defining a recess in a bottom thereof;
an injection body disposed in a top of the top plate, a top of the injection body defining a sprue, two first pouring runners connecting with the sprue, a lower end of each of the first pouring runners penetrating through the injection body; and
two slides received in two sides of the recess of the top plate respectively, each of the slides having a mating surface, the two mating surfaces of the two slides matching each other, a shaping recess being defined between the two mating surfaces for receiving a core insert therein, two injection runners being defined between the two mating surfaces and adjacent to two sides of the shaping recess respectively, each of the injection runners connecting with the lower end of the corresponding first pouring runner of the injection body to define a first runner, a lower portion of each of the injection runners defining a first tail runner and a pulling runner, two molding cavities being defined among the slides, the core insert and the injection body and being isolated by the core insert, the two molding cavities connecting with the corresponding first tail runners respectively.
